(19) United States
(12) Patent Application Publication
(10) Pub. No.: US 2016/0098567 A1
(43) Pub. Date: Apr. 7, 2016

(54) METHOD, ELECTRONIC DEVICE, AND NON-TRANSITORY COMPUTER READABLE RECORDING MEDIA FOR IDENTIFYING CONFIDENTIAL DATA

(71) Applicant: INSTITUTE FOR INFORMATION INDUSTRY, Taipei City (TW)

(72) Inventors: XIN-YAN YEH, NEW TAIPEI CITY (TW); CHIEN-TSUNG LIU, NEW TAIPEI CITY (TW)

(21) Appl. No.: 14/541,868

(22) Filed: Nov. 14, 2014

(30) Foreign Application Priority Data
Oct. 1, 2014 (TW) 103134231

(51) Int. Cl. G06F 21/60; H04L 29/06

(52) U.S. Cl. CPC G06F 21/60; H04L 63/04

(57) ABSTRACT

A method, an electronic device, and a non-transitory computer readable recording medium for identifying confidential data are provided. The electronic device determines whether a data has special formats by a format feature representing the special format. Then the electronic device further determines whether the special format of the data is the confidential data by confidential factors representing the special format to be the confidential data. Therefore, the method, the electronic device, and the non-transitory computer readable recording medium for identifying confidential data can correctly provide the confidential degree for the data having many confidential descriptions but few numbers and can identify the confidential data having the special format, thereby preventing the data leakage.

### FIELD

The instant disclosure relates to a method, an electronic device and non-transitory computer readable recording media for identifying confidential data, and more particularly, for identifying whether the data with special formats in the file are confidential data.

### BACKGROUND

The technology for identifying confidential data has become an issue regarding data protection. Using a mechanism for identifying confidential data, it has become possible to identify data that is extremely confidential.

The common technology for identifying confidential data can merely identify the personal information and confidential strings, and the confidential degree is usually proportioned to the types and amount of the found data. However, the confidential degree for the data having many confidential descriptions (e.g., resume, medical record, and the like) but few numbers cannot be correctly provided. Moreover, regarding to the traditional technology for identifying confidential data, after learning a large amount of known data and obtaining the feature of the known data, the data to be identified would be compared with the above feature so as to determine whether the data to be identified is the confidential data. Thus, via the traditional technology for identifying confidential data, it would be merely able to find the confidential data that is similar with or the same as the known data, but would not be able to find the confidential data of which the template or form is the same as the known data.

Therefore, if the confidential degree for the data having many confidential descriptions but few numbers can be correctly provided and the confidential data having the special format can be identified, this will prevent data leakage.

### SUMMARY

The disclosed embodiments include methods, electronic devices and non-transitory computer readable recording media for identifying confidential data.

The instant disclosure provides a method for identifying confidential data that is used in an electronic device. The electronic device stores a plurality of identification groups, and each identification group is corresponding to a special format. Each identification group has a format feature representing the special format and a plurality of confidential factors representing that the special format is the confidential data. The method for identifying confidential data comprises the following steps: capturing one of a plurality of data and defining the data as a captured data; capturing one of the format features and defining the format feature as a captured feature; determining whether the captured data has the corresponding special format according to the captured feature in the electronic device, if the electronic device determines that the captured data has the corresponding special format, determining whether an occurrence frequency of the confidential factors corresponding to the special formats in the captured data is larger than or equal to a confidential threshold, wherein if the electronic device determines that the occurrence frequency is larger than or equal to the confidential threshold, it means that the special formats in the captured data is the confidential data, and if the electronic device determines that the occurrence frequency is smaller than the confidential threshold, it means that the special formats in the captured data is not the confidential data; and determining whether there is the format feature that is not captured among the format features in the electronic device, if the electronic device determines that there is the format feature that is not captured among the format features, capturing the format feature that is not captured and defining the format feature as the captured feature so as to again determine whether the captured data has the corresponding special format according to the captured feature, and if the electronic device determines that there is no format feature that is not captured among the format features, capturing the next data and defining the next data as the captured data so as to again determine whether the captured data has the corresponding special format.

The instant disclosure provides an electronic device for identifying confidential data. The electronic device comprises a storage unit, a capturing unit and an identification unit. The storage unit is configured to store a plurality of identification groups, and each identification group is corresponding to a special format. Each identification group has a format feature representing the special format and a plurality of confidential factors representing that the special format is the confidential data. The capturing unit is electrically connected to the storage unit and configured to capture a plurality of data and the identification groups. The identification unit is electrically connected to the capturing unit and is configured to execute the following steps: capturing one of the data and defining the data as a captured data; capturing one of the format features and defining the format feature as a captured feature; determining whether the captured data has the corresponding special format according to the captured feature in the electronic device, if the electronic device determines that the captured data has the corresponding special format, determining whether an occurrence frequency of the confidential factors corresponding to the special formats in the captured data is larger than or equal to a confidential threshold, wherein if the electronic device determines that the occurrence frequency is larger than or equal to the confidential threshold, it means that the special formats in the captured data is the confidential data, and if the electronic device determines that the occurrence frequency is smaller than the confidential threshold, it means that the special formats in the captured data is not the confidential data; and determining whether there is the format feature that is not captured among the format features in the electronic device, if the electronic device determines that there is the format feature that is not captured among the format features, capturing the format feature that is not captured and defining the format feature as the captured feature so as to again determine whether the captured data has the corresponding special format according to the captured feature, and if the electronic device determines that there is no format feature that is not captured among the format features, capturing the next data and defining the next data as the captured data so as to again determine whether the captured data has the corresponding special format.

Moreover, the instant disclosure also provides a computer readable recording medium. The computer readable recording medium records a computer executable program. When the computer readable recording medium is read by an electronic device, the electronic device executes the computer executable program so as to implement the steps in the method as described above.

To sum up, the method, the electronic device and the non-transitory computer readable recording media for identifying confidential data provided by the instant disclosure can determine whether data with special formats are confidential data. Accordingly, the method, the electronic device and the non-transitory computer readable recording media for identifying confidential data provided by the instant disclosure can correctly provide the confidential degree for the data having many confidential descriptions but few numbers and can identify the confidential data having the special format, thereby preventing data leakage.

For further understanding of the instant disclosure, reference is made to the following detailed description illustrating the embodiments and examples of the instant disclosure. The description is only for illustrating the instant disclosure, not for limiting the scope of the claim.

### BRIEF DESCRIPTION OF THE DRAWINGS

Embodiments are illustrated by way of example and not by way of limitation in the figures of the accompanying drawings, in which like references indicate similar elements and in which:

FIG. 1 shows a schematic diagram of an electronic device for identifying confidential data according to an embodiment of the instant disclosure;

FIGS. 2A-2B shows a flow chart of a method for identifying confidential data according to an embodiment of the instant disclosure;

FIGS. 3A-3B shows a schematic diagram for the electronic device determining that the captured data has a table according to an embodiment of the instant disclosure;

FIGS. 4A-4B shows a schematic diagram for the electronic device determining that the captured data has a list according to an embodiment of the instant disclosure; and

FIGS. 5A-5B shows a schematic diagram for the electronic device determining that the captured data has a list according to an embodiment of the instant disclosure.

FIG. 6 shows a schematic diagram for the electric device determining whether the content of the special format in the received data is confidential data according to another embodiment of the instant disclosure.

### DETAILED DESCRIPTION OF EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings. The following description is going to illustrate the method, the electronic device and the non-transitory computer readable recording media for identifying confidential data provided by the instant disclosure with figures; however, it is not restricted by the embodiments below.

This embodiment provides an electronic device which determines whether there are special formats in the data based on the format features representing the special formats. After that, the electronic device further determines whether the information with the special format in the data is the confidential data based on a plurality of confidential factors of the confidential data representing the special format. Additionally, the embodiment of the instant disclosure also provides a method for identifying confidential data, which is used in the electronic device. Particularly, the method for identifying confidential data can be implemented in the electronic device via firmware, software or hardware circuits.

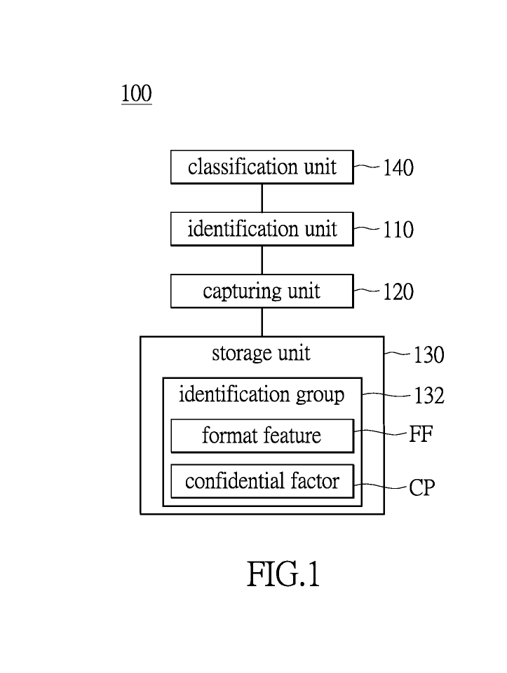

Please refer to FIG. 1, which shows a schematic diagram of an electronic device for identifying confidential data according to an embodiment of the instant disclosure. As shown in FIG. 1, the electronic device 100 for identifying confidential data is configured to identify whether the information with the special format in the data received by the electronic device 100 is confidential data, so as to prevent data leakage. In this embodiment, the electronic device 100 may be a smart phone, a desktop computer, a laptop or other electronic devices able to receive data.

The electronic device 100 is configured between the user computer and the remote server (not shown), so as to identify whether the information with special format in the data transmitted between the user computer and the remote server is confidential data. In another embodiment, the electronic device is configured to be electrically connected to the user computer (not shown), such that the electronic device 100 captures data in the user computer via the network connection and identifies whether data with the special format in the captured data is confidential data. In still another embodiment, the electronic device 100 is configured to be within the user computer (not shown), so when the user computer outputs data, the electronic device 100 identifies whether data with the special format in the output data is confidential data. Herein, the configuration of the electronic device is not limited. Accordingly, the electronic device 100 is able to prevent the confidential data from being obtained by others, and further to prevent data leakage.

The electronic device 100 comprises an identification unit 110, a capturing unit 120 and a storage unit 130. The storage unit 130 stores a plurality of identification groups 132. Each identification group 132 corresponds to a special format, and each identification group 132 has a format feature FF that correspondingly represents a special format. In other words, each identification group 132 has a format feature FF that is further provided to the identification unit 110 for identifying whether there is a special format in the data, which is corresponding to the format feature FF. For example, if the special format is a form, and the format feature FF of the form is that there are two ends of line in the same line. For example, if the special format is a list, and the format feature FF of the list is that there are several messages delivered by “TAB” key. For example, if the special format is a template defined by a user, the format feature FF of the template is the feature defined by the user. In this embodiment, each format feature FF includes at least one character, at least one string, at least one symbol, at least one number, at least one executing instruction, at least one format, or a combination thereof, and it is not limited thereto.

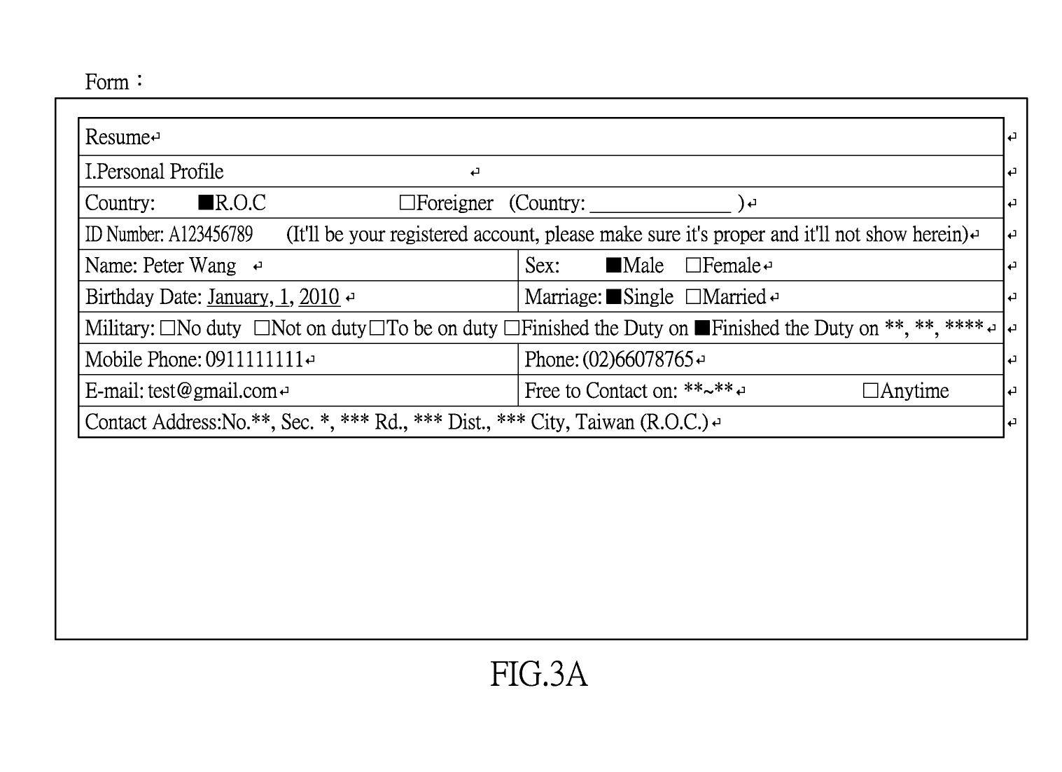

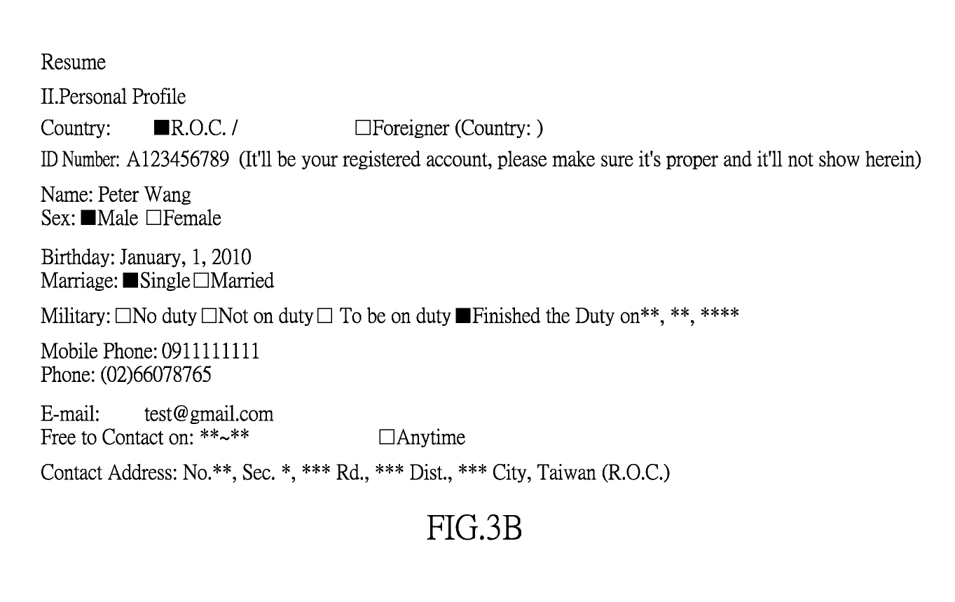

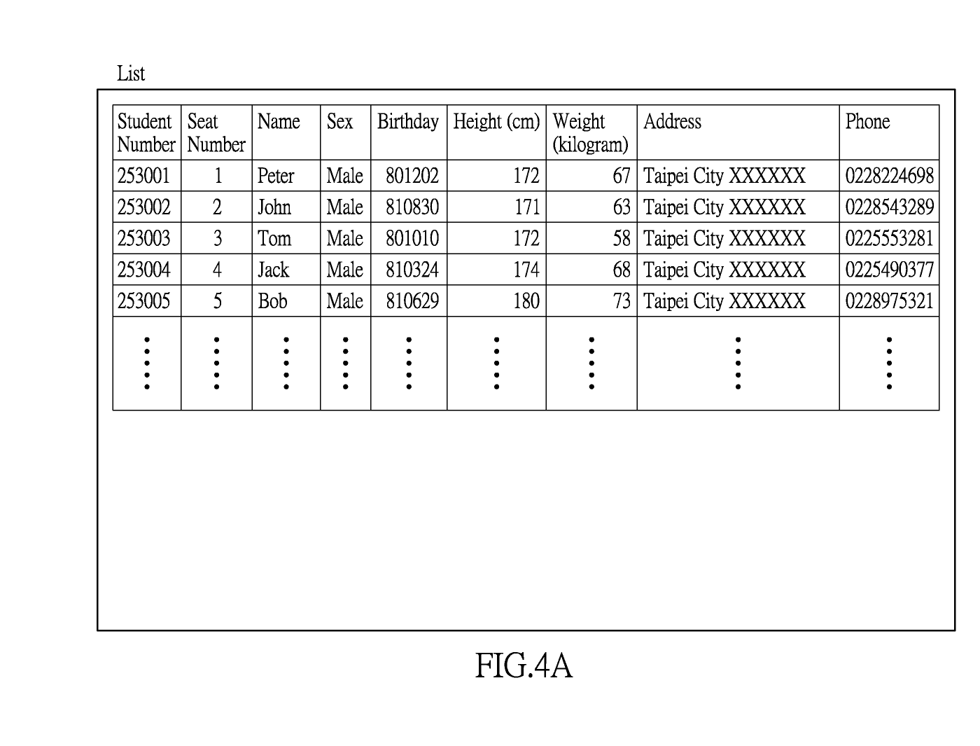

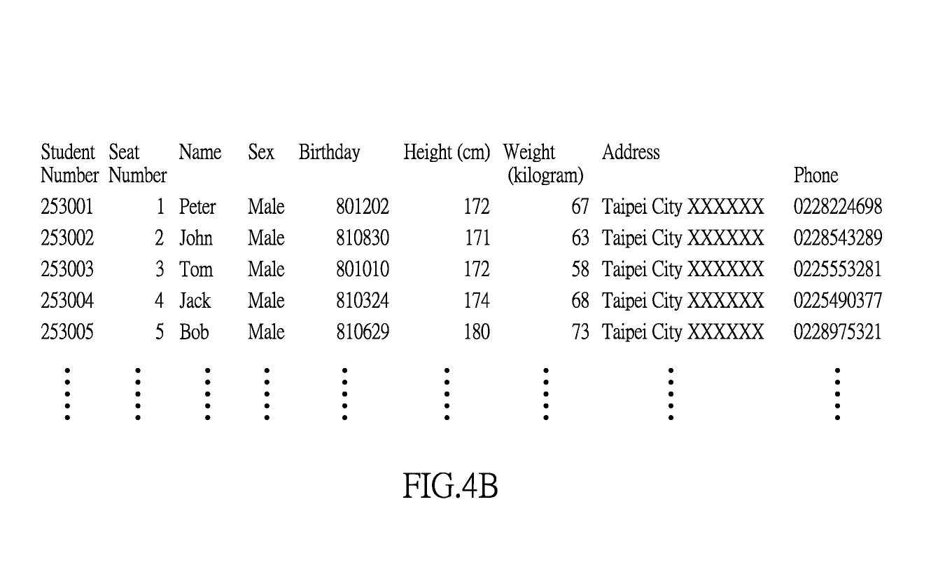

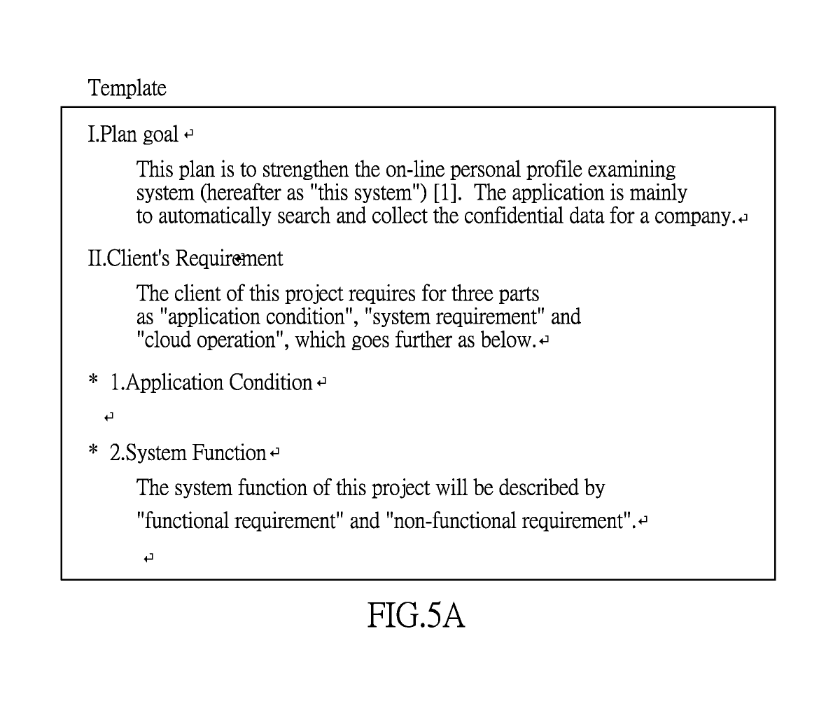

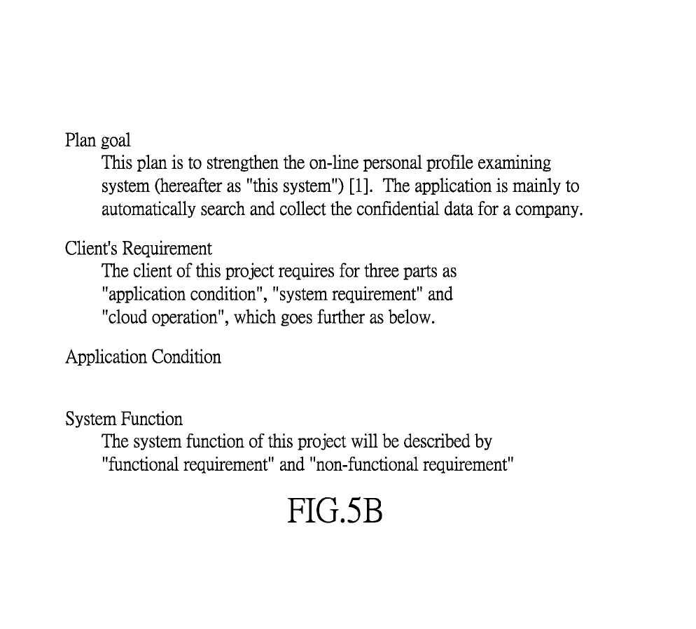

Moreover, each identification group 132 has a plurality of confidential factors CP that represents that the corresponding special format is the confidential data. That is, each identification group 132 has a plurality of confidential factors CP which are further provided to the identification unit 110 for identifying whether the information with the special format in data is the confidential data. For example, if the special format is a resume form (as shown in FIG. 3A), the confidential factors CP may be “name”, “ID number”, “mobile phone number”, “contact address” and the like. For another example, if the special format is an address list (as shown in FIG. 4A), the confidential factors CP may be “birth year and date”, “height”, “weight”, “address”, “phone number” and the like. Taking another example, if the special format is a template defined by a user (as shown in FIG. 5A), and the confidential factors CP may be “plan goal”, “customer demand” and the like which are defined by the user himself In this embodiment, the plurality of the confidential factors CP corresponding to each identification group 132 include at least one character, at least one string, at least one symbol, at least one number, at least one executing instruction, at least one format or a combination thereof, and it is not limited thereto.

The way to store a plurality of identification groups 132 in the storage unit 130 by the electronic device 100 can be considered as prior art, so it should be also well-known for those skilled in the art, and further description is therefore omitted. In this embodiment, the storage unit 130 may be a flash memory chip, a read-only memory chip or a dram chip that is volatile or non-volatile memory chip, and the storage unit 130 is a non-volatile memory chip.

Moreover, the electronic device 100 further comprises a display unit, used to display an identification interface (not shown), in order to provide a user to set the special formats (e.g. terms defined by the user) to be identified via the identification interface. Thereby the received data can be identified. Undoubtedly, if the special formats to be identified and the corresponding identification group 132 are saved in the storage unit 130 in advance, there would be no display unit needed either, and it is not limited thereto.

The capturing unit 120 is electrically connected to the storage unit 130 and captures several data and several identification groups 132, so as to provide the received data to the identification unit 110 for a further identification. The identification unit 110 is electrically connected to the capturing unit 120, and the identification unit 110 is a major operation center of the electronic device 100, used to execute each analysis, operation and control. In this embodiment, the identification unit 110 may be a central processing unit, a microcontroller, an embedded controller or other processing chips. The identification unit 110 and the capturing unit 120 are able to be integrated in the central processing unit, and it is not limited thereto.

The identification unit 110 is configured to execute the following steps so as to identify whether data with the special format in the received data is the confidential data.

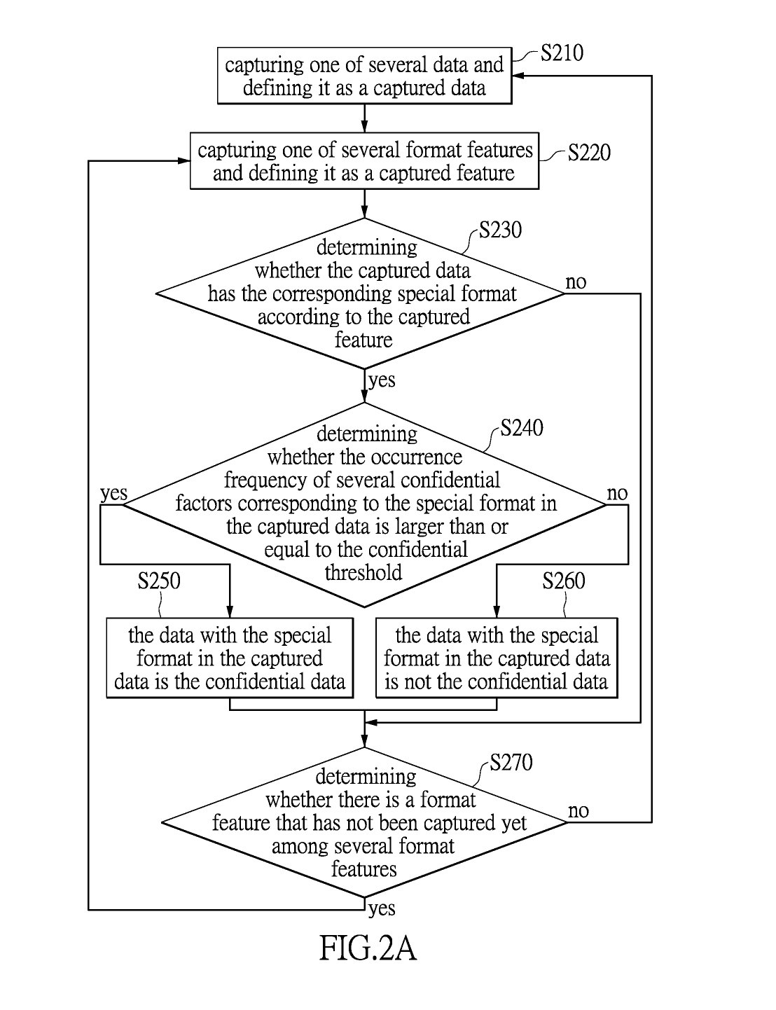

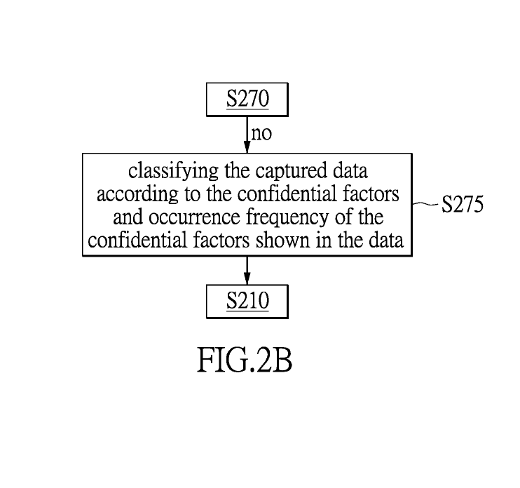

In conjunction with FIG. 1 and FIG. 2A. To begin with, the identification unit 110 captures one of several data via the capturing unit 120 and defines it as a captured data, so as to further identify whether the data with the special formats in the captured data is the confidential data (Step S210). The identification unit 110 captures the above mentioned several data from an external device via the capturing unit 120 or captures several data that is saved in the storage unit 130 in advance, and it is not limited thereto.

After that, the identification unit 110 captures one of several format features FF saved in the storage unit 130 via the capturing unit 120, and defines it as a captured feature (Step S220). Herein, the captured feature is representing certain special formats, such as a form, a list or other special formats. After that, the identification unit 110 determines whether the captured data has the corresponding special format according to the captured feature (Step S230). In other words, the identification unit 110 determines whether the captured data has a certain amount of the captured features, so as to determine whether the captured data has the special format of the format feature FF that is currently captured. In this embodiment, the special format may be a form, a list, a template defined by a user or other special formats having regular features, and it is not limited thereto. The format feature FF corresponding to the special format may be chosen merely from the features shown in the special formats, such as a message sent, successive spaces or the like by a specific key, and it is not limited thereto, either.

If the identification unit 110 determines that the captured data has the corresponding special format, it means that the captured data has the special format that is corresponding to the captured feature. Herein, the identification unit 110 further determines whether the data with the special format in the captured data is the confidential data (Step S240). On the other hand, if the identification unit 110 determines that the captured data has no corresponding special format, it means that the captured data does not have the special format that is corresponding to the captured feature. Herein, the identification unit 110 further determines whether there is a format feature FF that has not been captured yet among several format features FF (Step S270).

For example, if the special format is a form, the format feature FF of this is two ends of line in the same line, as shown in FIG. 3A. Therefore, if the capturing unit 120 captures the format feature FF representing the form, the identification unit 100 determines whether the occurrence frequency of two ends of line in the same line of the form is larger than or equal to a format threshold. If yes, the identification unit 110 identifies that the captured data has a special format representing the form. If not, the identification unit 110 identifies that the captured data does not have a special format representing the form. The above mentioned format threshold is set according to the actual form, and it is not limited thereto. After the identification unit 110 identifies whether the captured data has the special format representing the form, the capturing unit 120 captures the data in the form, as shown in FIG. 3B, so as to further determine whether the data in the form is the confidential data.

Again, for example, if the special format is a list, of which the format feature FF is a message sent by several TAB, as shown in FIG. 4A, if the capturing unit 120 captures the format feature FF representing the list, the identification unit 110 determines whether the amount of the above message shown in the list is larger than or equal to a format threshold. If yes, the identification unit 110 determines that the captured data has the special format representing the list. If no, the identification unit 110 determines that the captured data does not have the special format representing the list. The above format threshold is set according to an actual list, so it is not limited thereto. After the identification unit 110 determines whether the captured data has the special format representing the list, the capturing unit 120 captures the data in the list, as shown in FIG. 4B, so as to further determine whether the data in the list is the confidential data.

For another example, if the special format is a template defined by a user, of which the format feature FF may be a custom feature, the format feature FF is generated via the user's definition. As shown in FIG. 5A, the custom features are plan goal, customer demand and the like. Thus, if the capturing unit 120 captures the format feature FF representing the custom feature, the identification unit 110 determines whether the amount of the above custom feature shown in the template is larger than or equal to a format threshold. If yes, the identification unit 110 determines that the captured data has the special format representing the template. If no, the identification unit 101 determines that the captured data does not have the special format representing the template. The above mentioned format threshold is set according to an actual template, so it is not limited thereto. After the identification unit 110 determines whether the captured data has the special format representing the template, the capturing unit 120 captures the data in the template, as shown in 5B, so as to further determine whether the data in the template is the confidential data.

In the above mentioned three examples, those skilled in the art should appreciate the implementation manner when the identification unit 110 via the capturing unit 120 captures the special formats, such as a form, a list and a template, so the redundant information is not repeated herein.

Please return to the Step S240, the identification unit 110 determines whether the occurrence frequency of several confidential factors CP corresponding to the special format in the captured data is larger than or equal to the confidential threshold, so as to determine whether the data with the special format in the captured data is the confidential data. The confidential factors CP represent the possibility that the corresponding special format is the confidential data. Thus, if there are more confidential factors CP shown in the special format, it is more likely that the possibility that the special format is the confidential data. The setting regarding to the confidential factors CP has been described in the last embodiment, and thus it is not repeated thereto. Accordingly, if the identification unit 110 determines that the occurrence frequency of the confidential factors CP is larger than or equal to a confidential threshold, it means that the data with the special format in the captured data is the confidential data (Step S250). On the other hand, if the identification unit 110 determines that the occurrence frequency of the confidential factors CP is smaller than a confidential threshold, it means that the data with the special format in the captured data is not the confidential data (Step S260). The above mentioned confidential threshold is set according to the occurrence frequency of several confidential factors in the captured data, so it is not limited thereto.

For example, assumed that the special format is a form, as shown in FIG. 3A˜FIG. 3B. Particularly, the form has four terms that are considered confidential factors, which are “name”, “ID number”, “mobile phone number” and “contact address”, respectively. Besides, each term may have synonyms. For example, the term “name” may have synonyms such as “full name”, “title”, and “nick name”. Therefore, when evaluating, the identification unit 110 would consider these synonyms the same term. In this embodiment, the identification unit 110 evaluates the importance of each term in the form via a function of synonym STF(i), so as to obtain the relationship between each term and the form. The function of synonym STF(i) in this embodiment is as below.

$$STF ( i ) = \frac{{n}_{ij}}{{\sum }_{k} {N}_{kj}} \times {ω}_{i}$$

In particular, nᵢⱼ refers to the times that the i^{th} term shown in the j^{th} form, ωᵢ refers to the weight of the ith term, and ΣₖNₖⱼ refers to all k terms in the j^{th} form, wherein k≧0.

It should be noted that, the identification unit considers all synonyms as the same term. That is, if there are five terms found by the identification unit 110 in the form, which are “contact address”, “name”, “title”, “full name” and “ID number”, at this moment, the identification unit 110 considers the “contact address” the first term, the “name”, “title” and “full name” the second term and the “ID number” the third term. Assume that each term has its weight that is set as below: ω₁ is 0.5, ω₂ is 0.2 and ω₃ is 0.3. The identification unit 110 evaluates the importance of each term shown in the form via the function of synonym STF. Regarding to the first term, STF(1)=⅕*0.5=0.1. Regarding to the second term, STF(2)=⅗*0.2=0.12. Regarding to the third term, STF(3)=⅕*0.3=0.06.

After that, the identification unit 110 in this embodiment calculates the possibility of terms shown in the form, which are considered the confidential factors CP via a data function PIF. The data function PIF is as below.

$$PIF = \frac{{P}_{n}}{{P}_{t}}$$

In particular, Pₗ refers to the amount of terms currently considered the confidential factors, and Pₙ refers to the amount of terms considered the confidential factors in the form. Take the above case for example, the form has four terms considered the confidential factors CP, which are “name”, “ID number”, “mobile phone number” and “contact address”. The identification unit 110 finds five terms in the form, which are “contact address”, “name, “title”, “full name” and “ID number”, respectively. Also, the identification unit 110 classifies theses five terms as three kinds of terms. At this moment, the identification unit 110 calculates that PIF=¾, which means that the possibility of the terms considered the confidential factors shown in the form is 75%.

After that, the identification unit 110 calculates the occurrence frequency of the four confidential factors CP corresponding to the form in the captured data via a function of confidential data PIFV. The function of confidential data PIFV in this embodiment is below.

PIFV=(ΣₙSTF(i))×PIF

In particular, ΣₙSTF(i) refers to the sum of importance of each term shown in the form, and PIF refers to the possibility of terms considered the confidential factors in the form. From the above case, PIFV=(0.1+0.12+0.06)*0.75=0.21, which means that the occurrence frequency of the four confidential factors CP corresponding to the form in the captured data is 0.21.

Finally, the identification unit 110 determines whether the occurrence frequency is larger than or equal to a confidential threshold. From the above case, the confidential threshold in this embodiment is set as 0.1. Thus, the identification unit 110 determines that the occurrence frequency of the confidential factors CP, which is 0.21, is larger than the confidential threshold, which is 0.1, and it means that data with the form in the captured data is the confidential data. Accordingly, the identification unit 110 determines whether the data with the special format in the captured data is the confidential data via the Steps S210˜S260. Accordingly, the identification unit 110 may identify the confidential degree of the data with the special format in the captured data via the confidential factors CP representing the special format, so as to prevent the leakage of data having the highly confidential degree.

After that, the identification unit 110 determines whether there are still format features FF not yet been captured (Step S270). That is, the identification unit 110 further determines whether there are still other special formats in the captured data. If the identification unit 110 determines that there is a format feature FF not yet captured, it returns to the Step S220, so as to capture the format feature FF not yet captured via the capturing unit 120. At this moment, the identification unit 110 turns to define the format feature FF that has not been captured as the captured feature, so as to determine whether the captured data has corresponding special formats according to the newly defined captured feature. From the above case, after determining the format features FF of the form, if the identification unit 110 determines that the format feature FF representing the list has not yet been captured, the identification unit 110 turns to define the format feature FF representing the list as the captured feature (i.e., the format feature FF refers to the message sent by several times of pressing TAB key). Thereby, the identification unit 110 determines whether the captured data has the special format representing the list according to the captured feature.

On other hand, if the identification unit 110 determines that there is no format feature not yet been captured, it turns back to the Step S210 so as to capture the next data among several data. Further, the identification unit 110 turns to define the next data as the captured data, so as to again determine whether the captured data has the corresponding special formats.

Additionally, in conjunction to FIG. 1, FIG. 2A and FIG. 2B, the electronic device 100 further comprises a classification unit 140. The classification unit 140 is electrically connected to the identification unit 110 so as to classify the currently captured data. To be more detailed, if the identification unit 110 determines that there is no format feature FF not yet been captured, the classification unit 140 further classifies the currently captured data, so as to further determine the type of the special format in the captured data (Step S275). After the classification unit 140 has classified the currently captured data, the identification unit 110 turns back to the Step S210 so as to capture the next data in among several data. For example, the classification unit 140 classifies the captured data having forms into the resume, the salary table, the medical record or other forms of which the confidential degree is high. Also, the classification unit 140 classifies the captured data having lists into the contact list, the extension list or other lists of which the confidential degree is high.

In this embodiment, all data is correlated, so the classification unit 140 classifies the currently captured data according to several confidential factors of the special formats and the times that the above confidential factors CP show in all data. For example, the classification unit 140 has five terms “resume”, “name”, “ID number”, “mobile phone number” and “contact address” as the confidential factors CP. The classification unit 140 classifies the currently captured data according to the above five terms and the times that the above terms show in all data. Undoubtedly, if there is no correlation between all data, the classification unit 140 classifies the currently captured data merely according to several confidential factors CP of the special format, and it is not limited thereto.

Moreover, the classification unit 140 in this embodiment also classifies the currently captured data via a classification algorithm, such as TFIDF (Term Frequency-Inverse Document Frequency), SVM (Support Vector Machines), Bayesian classification or BPN network (Back Propagation Neural network), so as to classify the captured data more precisely. The skilled in the art should appreciate the implementation manner when the classification unit 140 classifies the captured data via a classification algorithm, so the redundant information is not repeated herein.

Accordingly, the classification unit 140 classifies the captured data having special formats. Thus, after all data has been identified, the user knows the types of special formats in all data, so as to further manage all data.

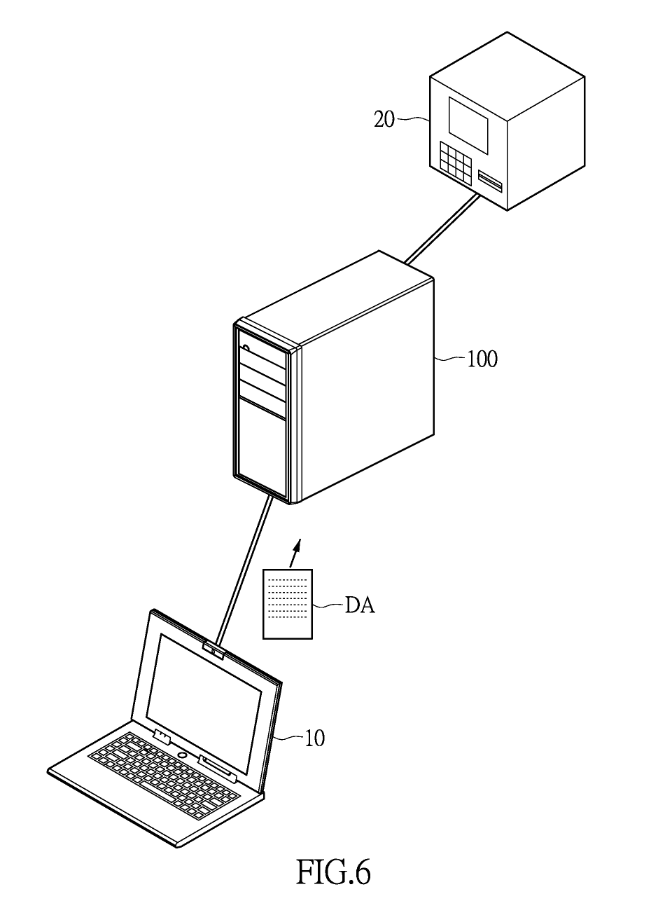

The following description is based on the example that a user transmits a data DA to a remote server 20 via a user computer 10. As shown in FIG. 6, the electronic device 100 is configured between the user computer 10 and the remote server 20, so as to determine whether the data with a special format in the data DA transmitted by the user computer is the confidential data. For the convenience in the description, the data DA in this embodiment has a form as shown in FIG. 3A, and the captured format feature FF is the special format representing a form.

In conjunction to FIG. 1, FIG. 3A and FIG. 6, during transmitting the data DA from the user computer 10 to the remote server 20, the identification unit 110 of the electronic device 100 captures the captured data DA via the capturing unit 120. At this moment, the electronic device 100 further determines whether the data with special formats in the data DA is the confidential data. It should be noted that, the data DA will not been transmitted to the remote server 20 temporarily in order to prevent the leakage of the confidential data.

To begin with, the identification unit 110 of the electronic device 100 determines that the data DA has the special format representing a form according to the currently captured format feature FF (i.e., the format feature FF refers to the special format representing for the form). The implementation manner for the identification unit 110 determining whether the data DA has the special format representing the form has been illustrated in the above embodiment, so the redundant information is not repeated herein.

After that, the identification unit 110 of the electronic device 100 determines the data with the form in the data DA is the confidential data according to the occurrence frequency of several confidential factors CP corresponding to the special format representing the form in the data DA. The implementation manner for the identification unit 110 determining whether the data with the special format representing the form in the data DA is the confidential data has been illustrated in the above embodiment, so the redundant information is not repeated herein.

Further, the identification unit 110 of the electronic device 100 further determines whether there is still a format feature FF that has not yet been identified. In this embodiment, the identification unit 110 determines that there is no format feature FF that has not yet been identified. That is, the identification unit 110 has determined all special formats in the data DA. Further, the classification unit 140 of the electronic device 100 classifies the data DA according to several confidential factors CP, and classifies the data DA into a resume. The implementation manner for the classification unit 140 classifying the data DA into the resume has been illustrated in the above embodiment, so the redundant information is not repeated herein.

At this moment, the electronic device 100 determines the data with the form in the data DA transmitted from the user computer 10 is the resume, and this resume is considered confidential data. After the electronic device 100 determines the data with the form in the data DA is the confidential data, it continues to the follow-up processing according to the actual information secure protection. For example, the electronic device 100 does not allow the data DA to be transmitted to the remote server 20 and informs the system administrator that the user computer 100 is transmitting the confidential data to the remote server 20. Accordingly, the electronic device 100 identifies whether the data with the special formats in the output data DA is the confidential data, so as to prevent others from obtaining the confidential data and further to prevent the leakage of data DA which is important.

Besides, the present invention also provides a non-transitory computer readable recording medium so as to save a computer program implementing the above method of identifying the confidential data in order to execute the above steps. The non-transitory computer readable recording medium may be a floppy disk, a hard disk, an optical disc, a flash disk, a magnetic tape or other recording medium that is well-known for the skilled in the art.

To sum up, the method, the electronic device and the non-transitory computer readable recording media for identifying confidential data provided by the instant disclosure can determine whether data with special formats are confidential data. Accordingly, the method, the electronic device and the non-transitory computer readable recording media for identifying confidential data provided by the instant disclosure can correctly provide the confidential degree for the data having many confidential descriptions but few numbers and can identify the confidential data having the special format, thereby preventing data leakage.

The descriptions illustrated supra set forth simply the embodiments of the instant disclosure; however, the characteristics of the instant disclosure are by no means restricted thereto. All changes, alterations, or modifications conveniently considered by those skilled in the art are deemed to be encompassed within the scope of the instant disclosure delineated by the following claims.

What is claimed is:

1. A method for identifying confidential data, used in an electronic device, the electronic device storing a plurality of identification groups, each identification group corresponding to a special format, each identification group having a format feature representing the special format and a plurality of confidential factors representing that the special format is the confidential data, and the method for identifying confidential data comprising:
capturing one of a plurality of data and defining the data as a captured data;
capturing one of the format features and defining the format feature as a captured feature;
determining whether the captured data has the corresponding special format according to the captured feature in the electronic device, if the electronic device determines that the captured data has the corresponding special format, determining whether an occurrence frequency of the confidential factors corresponding to the special formats in the captured data is larger than or equal to a confidential threshold, wherein if the electronic device determines that the occurrence frequency is larger than or equal to the confidential threshold, it means that the special formats in the captured data is the confidential data, and if the electronic device determines that the occurrence frequency is smaller than the confidential threshold, it means that the special formats in the captured data is not the confidential data; and
determining whether there is the format feature that is not captured among the format features in the electronic device, if the electronic device determines that there is the format feature that is not captured among the format features, capturing the format feature that is not captured and defining the format feature as the captured feature so as to again determine whether the captured data has the corresponding special format according to the captured feature, and if the electronic device determines that there is no format feature that is not captured among the format features, capturing the next data and defining the next data as the captured data so as to again determine whether the captured data has the corresponding special format.

2. The method for identifying confidential data according to claim 1, wherein if the electronic device determines that the captured data does not have the corresponding special format, determining whether there is the format feature that is not captured among the format features.

3. The method for identifying confidential data according to claim 1, wherein after the electronic device determines that there is no format feature that is not captured among the format features, the method further comprises: the electronic device classifying the captured data according the confidential factors and occurrence frequency of the confidential factors shown in the data.

4. The method for identifying confidential data according to claim 1, wherein in the step of determining whether the captured data has the corresponding special format according to the captured feature, the captured feature includes two ends of line in the same line, and if the electronic device determines that occurrence frequency of two ends of line in the same line of the special format is larger than or equal to a format threshold, the electronic device determines the captured data has the special format.

5. The method for identifying confidential data according to claim 1, wherein in the step of determining whether there is the corresponding special format in the captured data according to the captured feature, the format feature includes a message sent by a specific key, and if the amount of the message in the special format is larger than or equal to a format threshold, the captured data is determined to have the special format.

6. The method for identifying confidential data according to claim 1, wherein in the step of determining whether there is the corresponding special format in the captured data according to the captured feature, the format feature includes a custom feature, and if the amount of the custom feature in the special format is larger than or equal to a format threshold, the captured data is determined to have the special format.

7. The method for identifying confidential data according to claim 1, wherein the confidential factors of each identification group includes at least one character, at least one string, at least one symbol, at least one number, at least one executing instruction, at least one format, or a combination thereof.

8. The method for identifying confidential data according to claim 1, wherein each format feature includes at least one character, at least one string, at least one symbol, at least one number, at least one executing instruction, at least one format, or a combination thereof.

9. An electronic device for identifying confidential data, comprising:
a storage unit, configured to store a plurality of identification groups, each identification group corresponding to a special format, and each identification group having a format feature representing the special format and a plurality of confidential factors representing that the special format is the confidential data;
a capturing unit, electrically connected to the storage unit and configured to capture a plurality of data and the identification groups; and
an identification unit, electrically connected to the capturing unit, and configured to execute the following steps:
capturing one of the data and defining the data as a captured data;
capturing one of the format features and defining the format feature as a captured feature;
determining whether the captured data has the corresponding special format according to the captured feature in the electronic device, if the electronic device determines that the captured data has the corresponding special format, determining whether an occurrence frequency of the confidential factors corresponding to the special formats in the captured data is larger than or equal to a confidential threshold, wherein if the electronic device determines that the occurrence frequency is larger than or equal to the confidential threshold, it means that the special formats in the captured data is the confidential data, and if the electronic device determines that the occurrence frequency is smaller than the confidential threshold, it means that the special formats in the captured data is not the confidential data; and
determining whether there is the format feature that is not captured among the format features in the electronic device, if the electronic device determines that there is the format feature that is not captured among the format features, capturing the format feature that is not captured and defining the format feature as the captured feature so as to again determine whether the captured data has the corresponding special format according to the captured feature, and if the electronic device determines that there is no format feature that is not captured among the format features, capturing the next data and defining the next data as the captured data so as to again determine whether the captured data has the corresponding special format.

10. The electronic device according to claim 9, wherein if the electronic device determines that the captured data does not have the corresponding special format, the identification unit determines whether there is the format feature that is not captured among the format features.

11. The electronic device according to claim 9, further comprising a classification unit, electrically connected to the identification unit, and when the identification unit determines that there is no format feature that is not captured among the format features, the classification unit classifying the captured data according the confidential factors and occurrence frequency of the confidential factors shown in the data.

12. The electronic device according to claim 9, wherein the captured feature includes two ends of line in the same line, and if the identification unit determines that occurrence frequency of two ends of line in the same line of the special format is larger than or equal to a format threshold, the identification unit determines the captured data has the special format.

13. The electronic device according to claim 9, wherein the format feature includes a message sent by a specific key, and if the amount of the message in the special format is larger than or equal to a format threshold, the captured data is determined to have the special format.

14. The electronic device according to claim 9, wherein the format feature includes a custom feature, and if the amount of the custom feature in the special format is larger than or equal to a format threshold, the captured data is determined to have the special format.

15. The electronic device according to claim 9, wherein the confidential factors of each identification group includes at least one character, at least one string, at least one symbol, at least one number, at least one executing instruction, at least one format, or a combination thereof.

16. The electronic device according to claim 9, wherein each format feature includes at least one character, at least one string, at least one symbol, at least one number, at least one executing instruction, at least one format, or a combination thereof.

17. The electronic device according to claim 9, wherein the electronic device is configured between a user computer and a remote server, so as to identify whether the special format in each data transmitted between the user computer and the remote server is the confidential data.

18. The electronic device according to claim 9, wherein the electronic device is electrically connected to a user computer, and the electronic device captures the data in the user computer via a network connection, so as to identify whether the special format in each data is the confidential data.

19. The electronic device according to claim 9, wherein the electronic device is configured within a user computer, and when the user computer outputs the data, the electronic device captures the data so as to identify whether the special format in each data is the confidential data.

20. A non-transitory computer readable recording medium storing a computer executable program for causing an electronic device to perform the method according to claim 1.
